(19) United States
(12) Patent Application Publication
(10) Pub. No.: US 2022/0230340 A1
(43) Pub. Date: Jul. 21, 2022

(54) SYSTEM AND METHOD FOR OBJECT RECOGNITION USING 3D MAPPING AND MODELING OF LIGHT

(71) Applicant: BASF Coatings GmbH, Münster (DE)

(72) Inventors: Yunus Emre Kurtoglu, Southfield, MI (US); Matthew Ian Childers, Southfield, MI (US)

(21) Appl. No.: 17/617,112

(22) PCT Filed: Jun. 5, 2020
(86) PCT No.: PCT/EP2020/065751

§ 371 Date: Dec. 7, 2021

Related U.S. Application Data
(60) Provisional application No. 62/858,359, filed on Jun. 7, 2019.

(51) Int. Cl. G06T 7/586; G01S 7/4865; G06T 7/557

(52) U.S. Cl. CPC G06T 7/586; G06T 7/557; G01S 7/4865

(57) ABSTRACT

Described herein are a method and a system for object recognition via a computer vision application, where at least one object to be recognized is illuminated by at least one light source having light source specific radiance values, and radiance data of a scene including the object are measured when the scene is illuminated by the light source.

The present disclosure refers to a system and method for object recognition using 3D mapping and modeling of light.

### BACKGROUND

Computer vision is a field in rapid development due to abundant use of electronic devices capable of collecting information about their surroundings via sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the scene. While shape and appearance of objects in the environment acquired as 2D or 3D images can be used to develop an understanding of the environment, these techniques have some shortcomings.

One challenge in computer vision field is being able to identify as many objects as possible within each scene with high accuracy and low latency using a minimum amount of resources in sensors, computing capacity, light probe etc. The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.

Technique 2: Physical tags (scan/close contact based): Viewing angle dependent pigments, upconversion pigments, metachromics, colors (red/green), luminescent materials.

Technique 3: Electronic tags (passive): RFID tags, etc. Devices attached to objects of interest without power, not necessarily visible but can operate at other frequencies (radio for example).

Technique 4: Electronic tags (active): wireless communications, light, radio, vehicle to vehicle, vehicle to anything (X), etc. Powered devices on objects of interest that emit information in various forms.

Technique 5: Feature detection (image based): Image analysis and identification, i.e. two wheels at certain distance for a car from side view; two eyes, a nose and mouth (in that order) for face recognition etc. This relies on known geometries/shapes.

Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.

Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

Thus, a need exists for systems and methods that are suitable for improving object recognition capabilities for computer vision applications. One of the challenges with color space-based object recognition techniques is the unknown lighting conditions in a scene. Since most the environments of interest did not have controlled lighting conditions, 3D maps or networking capabilities, the dynamic modelling of lighting conditions in a scene was not possible. With the advances in IoT devices including lighting elements and 3D scanners along with improved processing power such light modelling techniques can be utilized for chemistry-based object recognition system designs.

### SUMMARY OF THE INVENTION

The present disclosure provides a system and a method with the features of the independent claims. Embodiments are subject of the dependent claims and the description and drawings.

According to claim 1, a system for object recognition via a computer vision application is provided, the system comprising at least the following components:
at least one object to be recognized, the object having an object specific reflectance spectral pattern and an object specific luminescence spectral pattern,
at least one light source which is configured to illuminate a scene which includes the at least one object under ambient light conditions, the at least one light source having light source specific radiance values,
a sensor which is configured to measure radiance data of the scene including the at least one object when the scene is illuminated by the light source,
a scene mapping tool which is configured to map the scene rendering at least a partial 3D map of the scene,
a data storage unit which comprises luminescence and/or reflectance spectral patterns together with appropriately assigned respective objects,
a data processing unit which is configured to analyse data received from the scene mapping tool and to merge the analysed data with the light source specific radiance values, and, based thereon, to calculate radiance of light incident at points in the scene, particularly at points on the at least one object, and to combine the calculated radiance of light incident at the points in the scene with the measured radiance of light returned to the sensor from points in the scene, particularly from points on the at least one object, thus forming a model of light spectral distribution and intensity at the at least one object in the scene, and to extract/detect the object specific luminescence and/or reflectance spectral pattern of the at least one object to be recognized out of the model of light spectral distribution and intensity and to match the extracted/detected object specific luminescence and/or reflectance spectral pattern with the luminescence and/or reflectance spectral patterns stored in the data storage unit, and to identify a best matching luminescence and/or reflectance spectral pattern and, thus, its assigned object,
   wherein at least the sensor, the scene mapping tool, the data storage unit and the data processing unit are in communicative connection with each other and linked together wirelessly and/or through wires and synchronized with the light source by default, thus forming an integrated system.

Some or all technical components of the proposed system may be in communicative connection with each other. A communicative connection between any of the components may be a wired or a wireless connection. Each suitable communication technology may be used. The respective components, each may include one or more communications interface for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

Within the scope of the present disclosure the terms “fluorescent” and “luminescent” are used synonymously. The same applies to the terms “fluorescence” and “luminescence”.

For forming the model of light spectral distribution and intensity, the points in the scene which are considered, are in the field of view or line of sight of at least one of the light source, the sensor and the 3D mapping tool. If a point in the scene is not in line of sight of any of the three components, that point is not considered for forming the model.

It is possible that the system comprises multiple sensors/cameras, light sources and/or mapping tools in the scene. Nevertheless, a partial coverage of the scene by any of those system components is sufficient, i.e. not all points in the scene need to be considered. It is to be stated that further calculation of radiance may be done inside, i. e. within the boundaries of, the at least partial 3D map obtained from the scene mapping tool. The 3D mapping tool, i. e. the scene mapping tool is used to map part of the scene, then the 3D map is used to calculate radiance of light incident at points in the partially mapped scene.

The light source can designed to connect automatically to at least one of the further components of the system such as the sensor, the scene mapping tool, the data storage unit and/or the data processing unit. However, the light source does not have to be linked to and/or networked with the other components of the system (if light source has predefined and known parameters, e. g. radiance values, pulse rates and timing, etc.), but need to be synchronized with the other components. This synchronization may be accomplished with measurements from the other components of the system, such as a spectral camera. It is also possible that the radiance of the light source is measured by at least one spectroradiometer, i.e. the system may be initialized with a spectroradiometer. However, generally this is only done for a setup of the system, but generally not in real time, i.e. not in operating mode of the system.

The light source specific radiance values comprise spectral characteristics, power and/or an emission angle profile (light output profile) of the at least one light source in the scene. Radiance of the at least one light source at points of the at least one object in the scene is calculated by using the light source specific radiance values, particularly the spectral characteristics, the power and/or the emission angle profile of the at least one light source in the scene and mapping a distance from the at least one light source to the at least one object in the scene.

According to a further embodiment of the system, the sensor is a multispectral or hyperspectral camera. The sensor is generally an optical sensor with photon counting capabilities. More specifically, it may be a monochrome camera, or an RGB camera, or a multispectral camera, or a hyperspectral camera. The sensor may be a combination of any of the above, or the combination of any of the above with a tuneable or selectable filter set, such as, for example, a monochrome sensor with specific filters. The sensor may measure a single pixel of the scene, or measure many pixels at once. The optical sensor may be configured to count photons in a specific range of spectrum, particularly in more than three bands. It may be a camera with multiple pixels for a large field of view, particularly simultaneously reading all bands or different bands at different times.

A multispectral camera captures image data within specific wavelength ranges across the electromagnetic spectrum. The wavelengths may be separated by filters or by the use of instruments that are sensitive to particular wavelengths, including light from frequencies beyond the visible light range, i.e. infrared and ultra-violet. Spectral imaging can allow extraction of additional information the human eye fails to capture with its receptors for red, green and blue. A multispectral camera measures light in a small number (typically 3 to 15) of spectral bands. A hyperspectral camera is a special case of spectral camera where often hundreds of contiguous spectral bands are available.

According to a further embodiment of the proposed system, the scene mapping tool is configured to perform a scene mapping by using a technique based on time of flight (TOF), stereovision and/or structured light. The scene mapping tool may comprise at least one of a time of flight system, such as TOF-cameras, a stereovision-based system, a light probe which emits structured light or any combination thereof. The structured light may be, for example, infrared light. Time of flight measurements can use infrared light, visible light or radar. Alternative scene mapping tools are (ultra)sound-based systems.

In still another aspect, the system is configured to use physical location (received via GPS), compass orientation, time of day, and/or weather conditions to model an effect of solar radiation on the illumination of the at least one object in the scene. Those influencing factors are considered in the model, i.e. incorporated into the model.

In a further aspect, the system is configured to use information of reflective and fluorescence properties of not only the at at least one object but also of other items in the scene to improve radiance mapping of the scene by means of bidirectional reflectance distribution functions (BRDFs) and bidirectional fluorescence distribution functions (BFDFs) to account for interreflections of reflected and fluoresced light throughout the scene.

According to another embodiment of the proposed system, the system comprises at least one white tile located at least one point in the scene, the white tile being configured to be used to measure radiance of the light source at the at least one point in the scene, wherein the measured radiance of the light source at the at least one point in the scene is used in conjunction with the 3D map and the light output profile of the light source to estimate radiance at other points in the scene. Highly reflective white tile(s) in the scene can be used to measure radiance from the light source at that point in the scene. This will also give the spectral characteristics of the light source. In conjunction with the 3D map of the scene, and assumptions/calculations about the light output profile of the light source, estimates of the radiance at other points in the scene can then be made. This may be most useful for systems that are not networked with information about the light source. The white tile(s) could also be used for “smart” systems that are networked with information about the light source to validate the calculations in addition to determining contributions from light sources outside of the system described.

The present disclosure also refers to a method for object recognition via a computer vision application, the method comprising at least the following steps:
providing at least one object to be recognized, the object having object specific reflectance and luminescence spectral patterns,
illuminating, by at least one light source, a scene which includes the at least one object under ambient light conditions, the light source having light source specific radiance values,
measuring, using a sensor, radiance data of the scene which includes the at least one object when the scene is illuminated by the light source,
mapping, using a scene mapping tool, the scene rendering an at least partial 3D map of the scene,
providing a data storage unit which comprises luminescence and/or reflectance spectral patterns together with appropriately assigned respective objects,
providing a data processing unit which is programmed to analyze data received from the scene mapping tool and merge the analysed data with the light source specific radiance values to calculate radiance of light incident at points in the scene, particularly at points of the at least one object, and to combine the calculated radiance of light incident at the points in the scene with the measured radiance of light returned to the sensor from points in the scene, particularly from the at least one object, thus forming a model of light spectral distribution and intensity at the at least one object in the scene, and to extract/detect the object specific luminescence and/or reflectance spectral pattern of the at least one object to be recognized out of the model of light spectral distribution and intensity and to match the extracted/detected object specific luminescence and/or reflectance spectral pattern with the luminescence and/or reflectance spectral patterns stored in the data storage unit, and to identify a best matching luminescence and/or reflectance spectral pattern and, thus, its assigned object,
   wherein the sensor, the scene mapping tool, the data storage unit and the data processing unit are communicating with each other wirelessly and/or through wires and synchronized with the light source by default, thus forming an integrated system.

According to one embodiment of the proposed method a scene mapping is performed by using a technique based on time of flight (TOF) and/or structured light and/or stereocameras wherein at least one of a time of flight system, a sound-based system, a stereovision-based system or any combination thereof is used. Infrared, visible, UV light can be used. Also radar, stereovision and/or ultrasound can be used here.

In a further aspect, radiance of the at least one light source at the at least one object in the scene is calculated using the light source specific radiance values, such as spectral characteristics, power and/or an emission angle profile of the at least one light source in the scene, and mapping a distance from the at least one light source to the at least one object in the scene.

Further, physical location (determined via GPS), compass orientation, time of day, and/or weather conditions may be used to model an effect of solar radiation on the illumination of the scene, thus adapting the model accordingly.

In still a further aspect, information of the reflective and fluorescence properties of items (not only of the at least one object) in the scene is used to improve radiance mapping of the scene by means of bidirectional reflectance distribution functions (BRDFs) and bidirectional fluorescence distribution functions (BFDFs) to account for interreflections of reflected and fluoresced light throughout the scene.

The model of light spectral distribution and intensity can be analyzed and displayed on a 2D map or as a 3D view via a respective output device, such as a display or a screen configured to issue a 3D map/view.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the data processing unit described herein and related components may be a portion of a local computer system or a remote computer or an online system or a combination thereof. The database, i.e. the data storage unit and software described herein may be stored in computer internal memory or in a non-transitory computer-readable medium. Within the scope of the present disclosure the database may be part of the data storage unit or may represent the data storage unit itself. The terms “database” and “data storage unit” are used synonymously.

The present disclosure further referes to a computer program product having instructions that are executable by a data processing unit as provided as component/part of the proposed system, the instructions cause the system to:
analyse data received from the scene mapping tool,
merge the analysed data with the light source specific radiance data,
calculate radiance of light incident at points in a scene, particularly at points of at least one object to be recognized, based on the merged data,
combine the calculated radiance of light incident at the points in the scene with the measured radiance of light returned to the sensor from points in the scene, particularly from points of the at least one object, thus forming a model of light spectral distribution and intensity at the at least one object in the scene,
extract an object specific luminescence and/or reflectance spectral pattern of the at least one object to be recognized out of the model of light spectral distribution and intensity,
match the extracted object specific luminescence and/or reflectance spectral pattern with luminescence and/or reflectance spectral patterns stored in the data storage unit, and,
identify a best matching luminescence and/or reflectance spectral pattern and, thus, its assigned object.

The present disclosure also refers to a non-transitory computer-readable medium storing instructions that, when executed by one or more data processing units as component(s) of the proposed system, cause the system to:
analyse data received from the scene mapping tool,
merge the analysed data with the light source specific radiance data,
calculate radiance of light incident at points in a scene, particularly at points of at least one object to be recognized, based on the merged data,
combine the calculated radiance of light incident at the points in the scene with the measured radiance of light returned to the sensor from points in the scene, particularly from points of the at least one object, thus forming a model of light spectral distribution and intensity at the at least one object in the scene,
extract an object specific luminescence and/or reflectance spectral pattern of the at least one object to be recognized out of the model of light spectral distribution and intensity,
match the extracted object specific luminescence and/or reflectance spectral pattern with luminescence and/or reflectance spectral patterns stored in the data storage unit, and,
identify a best matching luminescence and/or reflectance spectral pattern and, thus, its assigned object.

The present disclosure describes a method for object recognition and a chemistry-based object recognition system comprising a light source(s), a sensor, particulary a camera, a database of luminescence and/or reflectance spectral patterns of different objects and a computer/data processing unit that is configured to compute a spectral match of such luminescent and/or reflective objects of the database using various algorithms, a 3D map of scenes and a model of light spectral distribution and intensity (illuminance) at target objects in the field of view of the sensor. By incorporating the 3D maps of scenes and simple models of illuminance in the respective scenes with the rest of the network connected/synchronized system, luminescent/chemistry-based object recognition techniques are simplified and improved.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIG. 1 shows schematically an arrangement of an embodiment of the system according to the invention.

### DETAILED DESCRIPTION OF THE DRAWINGS

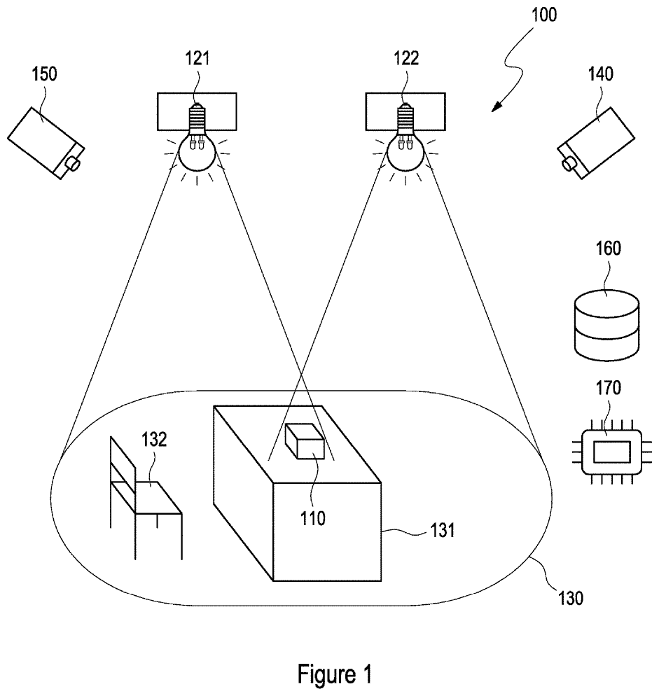

FIG. 1 shows an embodiment of the system 100 for object recognition via a computer vision application. The system 100 comprises at least one object 110 which is to be recognized. The object 110 has an object-specific reflectance spectral pattern and an object-specific luminescence spectral pattern. The object 110 is further located in a scene 130. The system 100 further comprises a first light source 121 and a second light source 122. Both light sources are configured to illuminate the scene 130 including the at least one object 110, preferably under ambient light conditions. The system 100 further comprises a sensor 140 which is configured to measure radiance data of the scene 130 including the at least one object 110 when the scene 130 is illuminated by at least one of the light sources 121 and 122. In the case shown here, the sensor 140 is a multispectral or a hyperspectral camera. The system 100 further comprises a scene mapping tool 150 which is configured to map the scene 130 rendering at least a partial 3D map of the scene 130. Further shown is a data storage unit 160 which comprises luminescence and/or reflectance spectral patterns together with appropriately assigned respective objects. The system 100 further comprises a data processing unit 170 which is configured to analyze data received from the scene mapping tool 150, merge the analyzed data with light source specific radiance parameters/values and calculate radiance of light incident at points in the scene 130, particularly at points of the object 110. The radiance of light incident at a specific point in the scene 130 can be formulated via a function of light intensity I(x, y, z) with (x, y, z) designating the space coordinates of the specific point within the scene 130. The function I(x, y, z) may be given in the simplest case by superposition of the light intensity I₁ of the first light source 121 and the light intensity I₂ of the second light source 122 at the specific point (x, y, z): I(x, y, z)=I₁(x, y, z)+I₂(x, y, z). The calculated radiance of light incident at the points in the scene 130 is combined with a measured radiance of light returned to the camera 140 from points in the scene, particularly from points of the object 110. Based on such combination of calculated radiance and measured radiance, a model of light spectral distribution and intensity at the object 110 in the scene is formed. The data processing unit 170 is further configured to calculate out of the model of light spectral distribution and intensity the object-specific luminescence and/or reflectance spectral pattern of the object 110 and to match the object-specific luminescence and/or reflectance spectral pattern of the object 110 with the luminescence and/or reflectance spectral patterns stored in the data storage unit 160. Thereby, a best matching luminescence and/or reflectance spectral pattern can be identified and the object 110 is identified as the object which is assigned within the database to this best matching luminescence and/or reflectance spectral pattern.

The camera 140, the scene mapping tool 150, the database 160 and the data processing unit 170 are in communicative connection with each other and linked together wirelessly and/or through wires, thus forming an integrated system. The light sources 121 and 122 may be linked to, but must not be linked to, the other components of the system. However, the light sources have to be synchronized with the other components. The light sources 121, 122 may be controlled by, for example, the data processing unit 170 or any other controller.

A further sensor, such as a spectroradiometer, which is configured to measure radiance data of the light sources 121, 122 may be useful but not necessary. Generally, a factory production specification will be available for the radiance of each light source 121, 122. Information about the light sources 121, 122, such as emission angle profile, power, or spectral characteristics may be combined with the partial 3D map of the scene 130 which is provided by the scene mapping tool 150, in order to calculate radiance at different points in the scene 130. That means that light radiance at points of interest in the scene 130, particularly at points of the object 110 is calculated based on the properties of the light sources 121 and 122 and the 3D map of the scene outputted by the scene mapping tool 150 (3D mapping tool).

Further information, such as information about a physical location, a compass orientation, a time of day, and weather conditions may be used to model an effect of solar radiation on the illumination of the scene 130. The scene mapping tool 150 may perform scene mapping using a technique based on time of flight and/or structured light using, for example, infrared light. However, visible light, radar, stereovision, and/or ultrasound may be possible alternatives. The scene mapping tool 150 may comprise at least one of a time of flight system (e. g. a LiDAR system), a sound-based system, a stereovision-based system or any combination thereof.

Knowledge of reflective and fluorescent properties of objects/items in the scene 130 may be used to improve the scene mapping with techniques such as bidirectional reflectance distribution functions and bidirectional fluorescence distribution functions to account for interreflections of reflected and fluoresced light throughout the scene 130. The bidirectional reflectance distribution function indicates how light is reflected at an opaque surface within the scene 130. By the knowledge of such bidirectional reflectance distribution functions and/or bidirectional fluorescence distribution functions the 3D mapping performed by the scene mapping tool can be improved as further effects due to reflected and fluoresced light emitted by further objects in the scene can be considered. Thus, the 3D mapping is more realistic as there are generally more than only the at least one object to be recognized within the scene.

Due to the knowledge or the measuring of spectral characteristics and power of the illuminants, i.e. the light sources 121 and 122 in the scene 130, and by mapping distances from the light sources 121, 122 to a plurality of objects in the scene 130, such as the desk 131 and the chair 132 which are previously known, accurate radiances can be derived and calculated at any point in the scene 130. The scene mapping can be performed by the scene mapping tool 150 using a variety of different techniques. A most common technique is based on time of flight measurements. A further possibility is the usage of structured light. When knowing the distances from the light sources 121 and 122 to objects 110, 131 and 132 in the scene 130, a 3D map of the scene can be formed, thus giving information about specific coordinates of the respective objects within the scene. By the knowledge of the coordinates of the object 110 which is to be recognized and the measured radiance data of the scene including the object 110 by the camera 140, the object-specific fluorescence spectral pattern can be filtered out of the calculated radiance model of the scene. As already mentioned above, the radiance mapping of the scene can be improved by using bidirectional reflectance distribution functions and bidirectional fluorescence distribution functions to account for interreflections of reflected and fluoresced light throughout the scene.

### LIST OF REFERENCE SIGNS

100 system

110 object

121, 122 light source

130 scene

131 desk

132 chair

140 sensor/camera

150 scene mapping tool

160 data storage unit/database

170 data processing unit

1. A system for object recognition via a computer vision application, the system comprising at least the following components:
at least one object to be recognized, the object having object specific reflectance and luminescence spectral patterns,
at least one light source which is configured to illuminate under ambient light conditions a scene, the scene including the at least one object, the at least one light source having light source specific radiance values,
a sensor which is configured to measure radiance data of the scene when the scene is illuminated by the light source,
a scene mapping tool which is configured to map the scene rendering at least a partial 3D map of the scene,
a data storage unit which comprises luminescence and/or reflectance spectral patterns together with appropriately assigned respective objects,
a data processing unit which is configured to analyse data received from the scene mapping tool and to merge the analysed data with the light source specific radiance values, and, based thereon, to calculate radiance of light incident at points in the scene, and to combine the calculated radiance of light incident at the points in the scene with the measured radiance of light returned to the sensor from points in the scene, thus forming a model of light spectral distribution and intensity at the at least one object in the scene, and to extract the object specific luminescence and/or reflectance spectral pattern of the at least one object to be recognized out of the model of light spectral distribution and intensity and to match the extracted object specific luminescence and/or reflectance spectral pattern with the luminescence and/or reflectance spectral patterns stored in the data storage unit, and to identify a best matching luminescence and/or reflectance spectral pattern and, thus, its assigned object,
wherein at least the sensor, the scene mapping tool, the data storage unit and the data processing unit are in communicative connection with each other and linked together wirelessly and/or through wires and synchronized with the light source by default, thus forming an integrated system.

2. The system according to claim 1, which is configured to calculate radiance of the at least one light source at the at least one object in the scene by using the light source specific radiance values, power and/or an emission angle profile of the at least one light source in the scene, and mapping a distance from the at least one light source to the at least one object in the scene.

3. The system according to claim 1, wherein the light source is linked with the scene mapping tool, the data storage unit and/or the data processing unit.

4. The system according to claim 1, wherein the sensor is a multispectral or hyperspectral camera.

5. The system according to claim 1 wherein the scene mapping tool is configured to perform a scene mapping by using a technique based on at least one of time of flight (TOF), stereovision, structured light, radar and/or ultrasound.

6. The system according to claim 1, which is configured to use physical location, compass orientation, time of day, and/or weather conditions to model an effect of solar radiation on the illumination of the at least one object in the scene.

7. The system according to claim 1, which is configured to use information of the reflective and fluorescence properties of the at least one object in the scene to improve radiance mapping of the scene by means of bidirectional reflectance distribution functions (BRDFs) and bidirectional fluorescence distribution functions (BFDFs) to account for interreflections of reflected and fluoresced light throughout the scene.

8. The system according to claim 1, further comprising at least one white tile located at least one point in the scene, the white tile being configured to be used to measure radiance of the light source at the at least one point in the scene, wherein the measured radiance of the light source at the at least one point in the scene is used in conjunction with the 3D map and a light output profile of the light source to estimate radiance at other points in the scene.

9. A method for object recognition via a computer vision application, the method comprising at least the following steps:
providing at least one object to be recognized, the object having object specific reflectance and luminescence spectral patterns,
illuminating, by at least one light source, a scene which includes the at least one object under ambient light conditions, the light source having light source specific radiance values,
measuring, using a sensor, radiance data of the scene including the at least one object when the scene is illuminated by the light source,
mapping, using a scene mapping tool, the scene rendering an at least partial 3D map of the scene,
providing a data storage unit which comprises luminescence and/or reflectance spectral patterns together with appropriately assigned respective objects, and
providing a data processing unit which is programmed to analyse data received from the scene mapping tool and merge the analysed data with the light source specific radiance values to calculate radiance of light incident at points in the scene, and to combine the calculated radiance of light incident at the points in the scene with the measured radiance of light returned to the sensor from points in the scene, thus forming a model of light spectral distribution and intensity at the at least one object in the scene, and to extract the object specific luminescence and/or reflectance spectral pattern of the at least one object to be recognized out of the model of light spectral distribution and intensity and to match the extracted object specific luminescence and/or reflectance spectral pattern with the luminescence and/or reflectance spectral patterns stored in the data storage unit, and to identify a best matching luminescence and/or reflectance spectral pattern and, thus, its assigned object,
wherein the sensor, the scene mapping tool, the data storage unit and the data processing unit are communicating with each other wirelessly and/or through wires and are synchronized with the light source by default, thus forming an integrated system.

10. The method according to claim 9, wherein a scene mapping is performed by using a technique based on at least one of time of flight (TOF), stereovision, structured light, radar, and/or ultrasound.

11. The method according to claim 9 wherein radiance of the at least one light source at the at least one object in the scene is calculated using spectral characteristics, power and/or an emission angle profile of the at least one light source in the scene, and mapping a distance from the at least one light source to the at least one object in the scene.

12. The method according to claim 9, wherein physical location, compass orientation, time of day, and/or weather conditions are used to model an effect of solar radiation on the illumination of the scene.

13. The method according to claim 9, wherein information of the reflective and fluorescence properties of the at least one object in the scene is used to improve radiance mapping of the scene by means of bidirectional reflectance distribution functions (BRDFs) and bidirectional fluorescence distribution functions (BFDFs) to account for interreflections of reflected and fluoresced light throughout of the scene.

14. The method according to claim 9, wherein the model of light spectral distribution and intensity can be analysed and displayed on a 2D map or as a 3D view.

15. A non-transitory computer-readable medium storing instructions that, when executed by one or more data processing units as provided as component of a system according to claim 1, cause the system to:
analyse data received from the scene mapping tool,
merge the analysed data with the light source specific radiance data,
calculate radiance of light incident at points in a scene, based on the merged data,
combine the calculated radiance of light incident at the points in the scene with the measured radiance of light returned to the sensor from points in the scene, thus forming a model of light spectral distribution and intensity at the at least one object in the scene,
extract an object specific luminescence and/or reflectance spectral pattern of the at least one object to be recognized out of the model of light spectral distribution and intensity,
match the extracted object specific luminescence and/or reflectance spectral pattern with luminescence and/or reflectance spectral patterns stored in the data storage unit, and,
identify a best matching luminescence and/or reflectance spectral pattern and, thus, its assigned object.

16. The system according to claim 1, wherein the data processing unit is configured to analyse data received from the scene mapping tool and to merge the analysed data with the light source specific radiance values, and, based thereon, to calculate radiance of light incident at points in the scene at the at least one object.

17. The system according to claim 1, wherein the data processing unit is configured to combine the calculated radiance of light incident at the points in the scene with the measured radiance of light returned to the sensor from points in the scene from the at least one object.

18. The system according to claim 1, which is configured to calculate radiance of the at least one light source at the at least one object in the scene by using the spectral characteristics, power and/or an emission angle profile of the at least one light source in the scene, and mapping a distance from the at least one light source to the at least one object in the scene.

19. The method according to claim 9, wherein the data processing unit is configured to analyse data received from the scene mapping tool and to merge the analysed data with the light source specific radiance values, and, based thereon, to calculate radiance of light incident at points in the scene at the at least one object.

20. The method according to claim 9, wherein the data processing unit is configured to combine the calculated radiance of light incident at the points in the scene with the measured radiance of light returned to the sensor from points in the scene from the at least one object.
